(19) United States
(12) Patent Application Publication
(10) Pub. No.: US 2026/0242026 A1
(43) Pub. Date: Aug. 20, 2026

(54) ELECTRIC SCOOTER

(71) Applicant: Ivan Kononov, Astana (KZ)

(72) Inventor: Ivan Kononov, Astana (KZ)

(21) Appl. No.: 18/992,579

(22) PCT Filed: Feb. 17, 2023
(86) PCT No.: PCT/RU2023/050031

§ 371 Date: Jan. 9, 2025

(30) Foreign Application Priority Data
Jul. 12, 2022 (RU) 2022118937

(51) Int. Cl. B62K 11/14; B62M 7/10

(52) U.S. Cl. CPC B62K 11/14; B62M 7/10

(57) ABSTRACT

The group of inventions relates to personal transportation vehicles, and more particularly to electric scooters. The essence of the group of inventions consists in a steering system for an electric scooter, which contains a rotatable platform comprising an annular base which is movably fastenable in an opening in a deck and has a central opening with a wheel disposed therein that is fastened to the base, wherein an electric motor is mounted on the rotatable platform. The technical result of the group of inventions is an increase in the repairability of an electric drive and a decrease in the risk of malfunction of the steering system of an electric scooter.

### REFERENCE TO RELATED APPLICATIONS

This application is a national phase application of and claims benefit of the PCT Patent Application No. PCT/RU2023/050031, titled “ELECTRIC SCOOTER”, filed on Feb. 17, 2023, which claims benefit of patent application RU 2022118937, titled ““ELECTRIC SCOOTER”, filed on Jul. 12, 2022 which are incorporated by reference herein in its entirety.

The group of inventions relates to personal transportation vehicles, and more particularly to electric scooters.

As a prototype, an electric scooter is selected containing a deck with a steering system, which includes an electric drive and a steering column connected to a wheel, wherein the electric drive is designed as a motorized wheel coupled to the column by a fork, wherein the fork is movably fastened to the deck by an inclined cylindrical element secured to the deck opening by a bearing assembly, thereby allowing the fork to tilt transversely to the scooter [CN109292032A, published on Feb. 1, 2019, IPC: B62K 15/006].

A shortcoming of the prototype is the low repairability of the electric drive and the high risk of a steering system malfunction. The poor repairability of the electric drive is due to the need to replace the motorized wheel in case of an electric drive malfunction, while the high risk of a steering system malfunction is because of the high load on the cylindrical element, the bearing assembly, and the deck at the place where the steering system and the deck join. The specified shortcomings complicate the use and maintenance of the electric scooter and require a new structural design of its steering system to eliminate the two existing issues and to improve the driving performance of the electric scooter.

The technical problem for which the group of inventions is designed is the need to improve the driving performance and reliability of the electric scooter.

The technical result of the group of inventions is an increase in the repairability of an electric drive and a decrease in the risk of malfunction of the steering system of the electric scooter.

An additional technical result of the group of inventions is improved repairability of the steering system of the electric scooter.

An additional technical result of the group of inventions is the possibility of making variable changes to the dynamic characteristics of an electric scooter.

The essence of the first invention from the group of inventions is as follows.

An electric scooter contains a deck with an opening for installing a steering system, which includes an electric drive and a steering column coupled to a wheel axle. In contrast to the prototype, the electric drive is designed as an electric motor with a follower, wherein the follower is fastened on the wheel and is capable of transmitting torque from the electric motor to the wheel, and the steering column is coupled to the wheel by a rotatable platform which is movably fastened in the deck opening by means of an annular base and a bearing assembly, wherein the annular base has an opening that aligns with the deck opening, wherein the wheel with the follower is placed in the base opening and fastened to the base, and the electric motor is mounted on the rotatable platform.

The essence of the second invention from the group of inventions is as follows.

The steering system of the electric scooter comprises a wheel, a steering column coupled to a wheel axle, and an electric drive capable of transmitting torque to the wheel. In contrast to the prototype, the steering system comprises a rotatable platform designed to fasten the steering column and comprising an annular base movably fastenable in the deck opening by means of a bearing assembly, and the electric drive is designed as an electric motor mounted on the rotatable platform and has a driver, a follower, and an actuating member, wherein the follower is fastened on the wheel and is capable of transmitting torque from the electric motor to the wheel, and the annular base has a central opening with a wheel placed therein and fastened to the base, wherein the electric motor is mounted on the rotatable platform.

The steering system includes the electric drive, which ensures dynamic stability of the scooter in the longitudinal plane. The electric drive is designed as an electric motor with a follower, wherein the follower is fastened on the wheel and is capable of transmitting torque from the electric motor to the wheel, thereby improving the repairability of the electric drive and reducing the risk of malfunction of an electric scooter steering system that contains such an electric drive, as it is possible to replace only the electric drive in case of a malfunction. Moreover, this allows for the installation of an electric motor with different power characteristics, which makes it possible to variably change the dynamic characteristics of the electric scooter.

The driver, the follower, and the actuating member improve the repairability of the electric drive, as they can be replaced in case of a malfunction. Pulleys, sprockets, cone disks, toothed gears, and other similar elements can be used as the driver and the follower. The actuating member transmits torque from the driver to the follower, and, depending on the type thereof, it can be a V-belt or a tooth belt, a chain, an additional toothed gear or as a driver or a follower designed as a toothed gear. Moreover, the structural design, which includes a driver, a follower, and an actuating member, provides for transmission functions, which makes it possible to vary the scooter torque or maximum speed characteristics, thus allowing for variable changes to the dynamic characteristics of the electric scooter.

The follower is fastened on the wheel and is capable of transmitting torque from the electric motor to the wheel. To achieve this, it can be rigidly fastened by detachable or fixed connection, or it can be connected to the wheel by a sleeve-type or elastic clutch, a freewheel, or other types of clutches.

The rotatable platform enables the steering system to rotate relative to the deck and contains an annular base for this purpose. The annular base has a central opening with the wheel placed therein and fastened to the base, wherein the follower is attached to the wheel, thereby ensuring that the wheel receives torque from the electric motor and rolls.

The central opening in the base can be of any shape and size suitable for mounting the wheel with the follower in the opening to the required depth. The wheel axle can traverse the axis of the central opening. The wheel can be secured to the annular base by fastening the wheel axle in the holes, grooves, or slots of the annular base. However, in order to improve the repairability of the electric scooter steering system and simplify the manufacturing of the annular base, the wheel can be fastened by using detachable wheel axle fasteners, such as side bars or clamps.

The rotatable platform is the place for mounting the electric motor, so the annular base can have holes or elements for the detachable or fixed mounting of the electric motor. In addition, to reduce the risk of the annular base failing, the rotatable platform can have an electric motor mounting bracket to connect the annular base and the steering column. In addition, to reduce the risk of a malfunction of the electric drive, the electric motor mounting bracket can be designed as a protection frame with a cavity for placing the electric motor.

The annular base can be monolithic; however, to improve repairability and simplify manufacturing, it can consist of detachable parts with the wheel fastened to one part and the electric motor and/or the steering column fastened to another one. It is preferable to have an insert between these two parts to improve load distribution and further reduce the risk of a malfunction of the electric scooter steering system.

The annular base is movably fastened in the deck opening, thereby allowing the steering column to turn the wheel. The movable fastening is provided by a bearing assembly that provides an interface between the outer side of the annular base and the surface and edge of the deck opening. The bearing assembly can consist of one or more sliding and/or rolling friction pairs. The annular base can have a rectangular, square, or any other simple or profiled cross-section. In order to reduce the risk of a malfunction of the steering system, the annular base side shall preferably have a U-shaped cross-section. In this case, the bearing assembly can consist of two friction pairs that can be mounted where the sides of the annular base with a U-shaped cross-section and the deck join.

The steering column can consist of a pole with handles equipped with the means to control and monitor the electric scooter characteristics. To fasten the steering column, the rotatable platform can have means for detachable or fixed connection, which can be located on the annular base or the electric motor mounting bracket (if available). The deck is a bearing surface for accommodating the rider.

The group of inventions can be made of known materials using known means, which indicates its compliance with the patentability criterion of industrial applicability.

The group of inventions is characterized by a set of substantial features unknown in the art; in particular, the electric drive is designed as an electric motor with a follower, wherein the follower is fastened on the wheel and is capable of transmitting torque from the electric motor to the wheel, and the steering column is coupled to the wheel by a rotatable platform which is movably fastened in the deck opening by means of an annular base with an opening that aligns with the deck opening, wherein the wheel with the follower is placed in the base opening and fastened to the base, and the electric motor is mounted on the rotatable platform. The presented structural design of the electric scooter and its steering system makes it possible to quickly replace the electric drive and/or electric drive elements that transmit torque from the electric motor to the wheel if they fail and improves the distribution of load on the junctions of the steering system and the deck due to the use of the annular base and placement of the wheel with the follower in the central opening of the base.

This delivers a technical result that increases the repairability of the electric drive and decreases the risk of a malfunction of the electric scooter steering system, thereby improving the driving performance and reliability of the electric scooter.

The group of inventions has a set of substantial features unknown in the art, which indicates its compliance with the novelty criterion for patentability.

An electric scooter with a steering system designed as a rotatable platform with an annular base that provides the turning function and accommodates the driving wheel of the electric scooter and all elements of the electric drive, including the electric motor also mounted on the rotatable platform, is unknown in the art. The presented structural design not only simplifies the use and maintenance of the electric scooter but also makes it possible to change the dynamic characteristics of the electric scooter in a wide range as the result of using a set of electric drive elements instead of a motorized wheel. Moreover, the presented structural design ensures a more efficient distribution of load on the deck. In general, this structural design makes it possible to manufacture the deck and individual elements of the electric drive from lightweight construction materials, thereby considerably reducing the weight of the electric scooter, which is of particular importance for a personal transportation vehicle used in an urban environment.

Therefore, the group of inventions complies with the inventive step criterion for patentability.

The inventions in the group of inventions are interrelated and form a single inventive concept that involves the steering system being a part of the electric scooter, which indicates compliance of the group of inventions with the criterion of unity of invention for patentability.

The following figures illustrate the group of inventions:

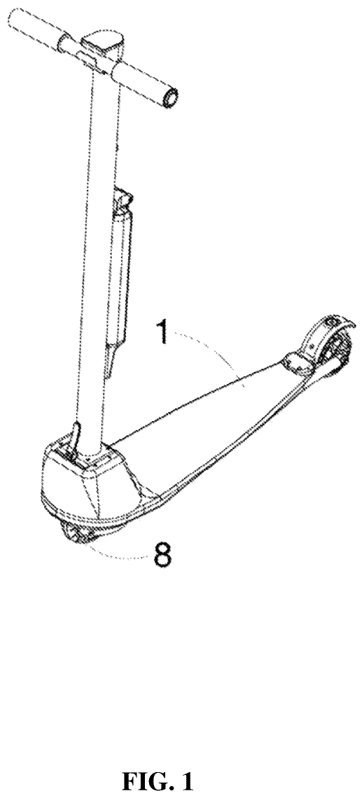

FIG. 1—an electric scooter; general isometric view;

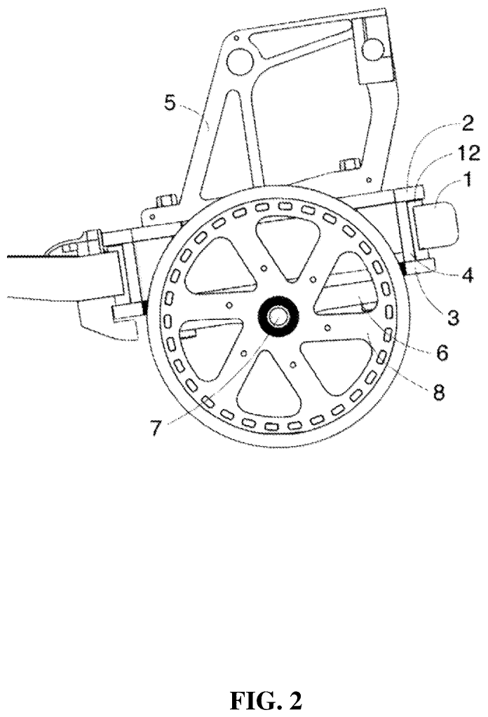

FIG. 2—a steering system of the electric scooter with the electric motor and the steering column dismantled; longitudinal section, side view;

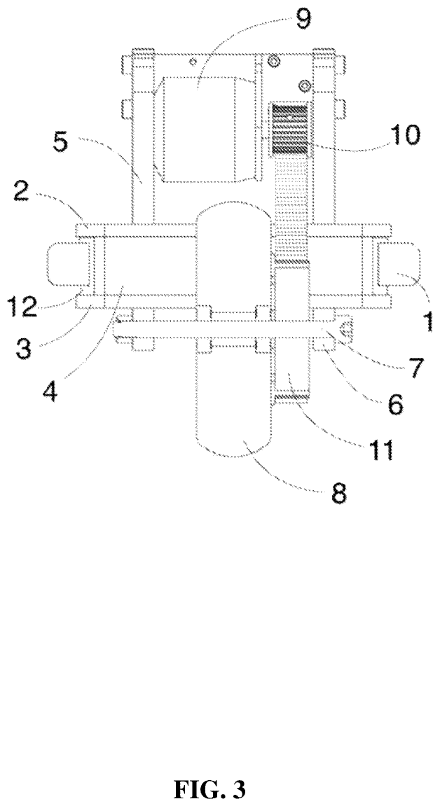

FIG. 3—the steering system of the electric scooter with the electric motor mounted; transverse section along the wheel axle, back view;

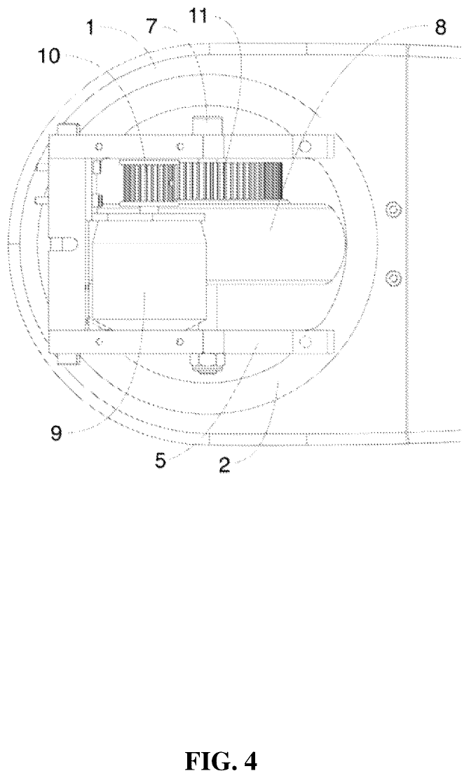

FIG. 4—the steering system of the electric scooter with the electric motor mounted; top view.

To illustrate the implementation and ensure a more complete understanding of the essence of the group of inventions, an embodiment is provided below, which can be changed or supplemented in any way, wherein the present group of inventions is not limited to the provided embodiment in any way.

The electric scooter contains a deck 1 with a steering system including a rotatable platform and an electric drive.

The rotatable platform comprises an annular base consisting of flanges 2 and 3 with an annular insert 4 therebetween, wherein a bracket 5, which is designed as a protection frame and to which the steering column is attached, is fastened to the flange 2, and an axle 7, to which wheel 8 is attached, is fastened to the flange 3 by means of side bars 6. The bracket 5, the flanges 2, 3, and the side bars 6 are fastened with common bolts and nuts.

The electric drive consists of an electric motor 9 fastened on the bracket 5 with bolts and nuts and a transmission system consisting of a pulley 10 fastened on the motor shaft 9 and a pulley 11 fastened on the disk of the wheel 8 and connected with the pulley 10 by means of a tooth belt. The wheel with the pulley 11 traverses the planes of the holes of the flanges 2, 3 and the annular insert 4.

The rotatable platform is movably fastened in the opening of the deck 1 by a bearing assembly 12 mounted between the flanges 2, 3 and the deck 1 and consisting of two friction pairs mounted where the sides of the annular base with a U-shaped cross-section and the deck 1 join.

The group of inventions operates as follows.

The electric scooter is operated by a user, wherein by fastening the wheel to the flange 3 by means of the side bars 6 and fastening the steering column to the flange 2, as well as an interlink of the flanges with the annular insert 4, the shock absorbing characteristics of the rotatable platform structural design are improved, and distribution of the load on the edge of the opening in the deck 1 reduces the risk of defects to both the deck 1 and the annular base, thus reducing the risk of a steering system malfunction. If one of the elements 2, 3, 4, or 6 breaks down, it is possible to replace just one element without having to replace the annular base or the entire rotatable platform.

If the electric motor 9 breaks down, it is not necessary to dismantle or replace the wheel, and the new electric motor 9 can be mounted just by unfastening and fastening the bolts and nuts used to fasten the motor to the bracket 5. Moreover, it is possible to install an electric motor 9 of different power characteristics and to change the torque or maximum speed characteristics of the electric scooter by using pulleys 10 and 11 of other diameters or by replacing them with other elements.

This delivers a technical result that increases the repairability of the electric drive and decreases the risk of a malfunction of the electric scooter steering system, thereby improving the driving performance and reliability of the electric scooter.

1. An electric scooter comprising a deck with an opening for installing a steering system, which includes an electric drive and a steering column coupled to a wheel axle, characterized in that the electric drive is designed as an electric motor with a follower, wherein the follower is fastened on the wheel and is capable of transmitting torque from the electric motor to the wheel; the steering column is coupled to the wheel by a rotatable platform, which is movably fastened in the deck opening by means of an annular base and a bearing assembly, wherein the annular base has an opening that aligns with the deck opening, wherein the wheel with the follower is placed in the base opening and fastened to the base, and the electric motor is mounted on the rotatable platform.

2. The electric scooter according to claim 1 characterized in that the wheel is fastened to the annular base by detachable wheel axle fasteners.

3. The electric scooter according to claim 1 characterized in that the rotatable platform comprises an electric motor mounting bracket for connecting the annular base and the steering column.

4. The electric scooter according to claim 3 characterized in that the bracket is designed as a protection frame having a cavity for placing the electric motor.

5. The electric scooter according to claim 1 characterized in that the annular base consists of detachable parts with the wheel fastened to one part and the electric motor and/or the steering column fastened to another one.

6. The electric scooter according to claim 5 characterized in that the two detachable parts of the annular base have an insert therebetween.

7. A steering system for the electric scooter comprising a wheel, a steering column coupled to a wheel axle, and an electric drive capable of transmitting torque to the wheel, characterized in that it contains a rotatable platform designed to fasten the steering column and comprising an annular base movably fastenable in the deck opening by means of a bearing assembly, and the electric drive is designed as an electric motor mounted on the rotatable platform and having a driver, a follower, and an actuating member, wherein the follower is fastened on the wheel and is capable of transmitting torque from the electric motor to the wheel by means of an actuating member, and the annular base has a central opening with a wheel placed therein and fastened to the base.

8. The steering system according to claim 8 characterized by the U-shaped cross-section of the annular base side.

9. The steering system according to claim 9 characterized in that the bearing assembly consists of two friction pairs mounted at junctions of the annular base sides and the deck.
